(19) United States
(12) Patent Application Publication
(10) Pub. No.: US 2021/0011472 A1
(43) Pub. Date: Jan. 14, 2021

(54) SYSTEM, DEVICE AND METHOD FOR TIME LIMITED COMMUNICATION FOR REMOTELY CONTROLLED VEHICLES

(71) Applicant: SafeShoot Ltd., Binyamina (IL)

(72) Inventor: Amir SCHECHTER, Binyamina (IL)

(21) Appl. No.: 17/033,756

(22) Filed: Sep. 26, 2020

Related U.S. Application Data
(63) Continuation-in-part of application No. 14/767,929, filed on Aug. 14, 2015, now Pat. No. 9,772,155.

(30) Foreign Application Priority Data
Sep. 26, 2019 (IL) 269691

(51) Int. Cl. G05D 1/00; H04B 7/185; G05D 1/10; G08G 5/00; G08G 5/04; G01S 19/42; G05D 1/02; G08G 3/02; G01D 21/02

(52) U.S. Cl. CPC G05D 1/0022; H04B 7/18506; G05D 1/106; G05D 1/0016; G01D 21/02; G08G 5/04; G01S 19/42; G05D 1/0206; G08G 3/02; G08G 5/0039

(57) ABSTRACT

The present invention is for a system, device and method for remotely controlled vehicles for controlling the course of such a vehicle in a crowded space by utilizing a time limited control signal communication including route maneuvers during an emergency situation so as to avoid the emergency situation.

### CROSS-REFERENCE TO RELATED APPLICATIONS

This application claims priority under the Paris Convention to Israel Patent Application No. 269691, filed Sep. 26, 2019. This application is also a continuation-in-part of U.S. application Ser. No. 14/767,929, filed Aug. 14, 2015, now U.S. Pat. No. 9,772,155, granted Sep. 26, 2017, which is a National Stage Application of PCT Application No. PCT/IL2014/050925, filed Oct. 24, 2014, which claims priority to Israel Patent Application No. 229078, filed Oct. 24, 2013. All of the preceding applications are hereby incorporated herein by reference in their entireties.

### FIELD OF THE INVENTION

The present invention relates generally to remotely controlled vehicles and, more specifically, to a system, device and method for controlling the course of such a vehicle in a crowded space/arena/area by utilizing time limited communication.

### BACKGROUND OF THE INVENTION

Remotely controlled vehicles such as Aerial Vehicles (“AV”), Unmanned Aerial Vehicle (“UAV”), flying robots, terrestrial vehicles, terrestrial robots, water vehicles, watercrafts, water vessels, amphibious robots, amphibious vehicles, and similar remotely controlled robot and/or vehicle technology has proven to be a valuable tool in both the civilian and military arenas. For example, such remotely controlled vehicles has proven valuable for various mission profiles involving intelligence, police surveillance, reconnaissance, and payload delivery. Similarly uses of such remotely controlled vehicles has been used in civilian applications for example for the purpose of the delivery of goods.

The deployment of such remotely controlled vehicles and/or robots however can be problematic in a crowded space and/or arena. For example, in the contexts of low-altitude urban reconnaissance, a UAV, such as a micro-air vehicle (“MAV”), may encounter both large and small obstacles that may be fixed or moving, whose position is not known in advance. The crowded space surfaces a need for the ability to adapt to and to maneuver in constrained, cluttered environments whether in sea, land or air. For example, due to the cluttered environment, aerial vehicles are now more prone to crashing or colliding with objects and/or each other. Furthermore, many of the available aerial vehicles are often controlled by less-skilled users and/or pilots who may, in turn, cause a collision.

Despite the development of various systems to try to minimize the number of such collision incidents, they unfortunately continue to occur. Accordingly, there remains a need for improved control of aerial vehicles so as to minimize collisions between various obstacles and especially with other aerial vehicles.

### SUMMARY OF THE INVENTION

Embodiments of the present invention provide a safety device that may be readily associated or incorporated with at least a portion of a remotely controlled vehicle and/or robot. The device acts to monitor, foresee, and predict potential threats and/or emergency situations for the remotely controlled robot and/or vehicle. When such an emergency situation is identified the device is configured to abstract a control signal that causes the robot and/or vehicle to undertake an maneuver so as to avoid and/or alleviate and/or circumvent the emergency situation, for example including but not limited to a collision.

In embodiments the routing maneuver is provided by abstracting and communicating a control signal to the aerial vehicle's intrinsic and/or internal control module and/or sensors so as to cause the robot and/or remotely controlled vehicle to maneuver so as to change its course to alleviate and/or avoid the emergency situation.

In some embodiments the abstracted control signal may be communicated to at least one or more user(s) and/or operator(s) and/or controller(s) and/or third party so as to allow and direct them to perform the abstracted maneuver control signal so as to avoid the emergency situation.

In some embodiments the abstracted control signal comprises virtual sensory data so as to cause the aerial vehicle's internal controller and/or flight path controller to recalculate its route in view of the virtual sensory data communicated thereto, therein the control signal, causes the vehicle to move out of harm's way avoiding the detected emergency situation.

In some embodiments the abstracted control signal provides maneuvering instructions directly to the remote vehicle controller module and/or unit in order to cause the vehicle and/or robot to maneuver and/or reroute so as to move out of harm's way avoiding the detected emergency situation.

In embodiments the maneuvering control signal instructs the vehicle to maintain a safe distance. For example, for an aerial vehicle the safe distance may be defined as maintaining at least one of: vertical distance of at least 150 meters and/or a horizontal distance of at least 300 meters. In some embodiments the safety distance may be defined as maintaining at least one of a vertical distance of at least 50 meters and/or a horizontal distance of at least 100 meters. In some embodiments the safety distance may be defined as maintaining at least one of a vertical distance of at least 100 meters and/or a horizontal distance of at least 150 meters. In some embodiments the safety distance may be defined as maintaining at least one of a vertical distance of at least 150 meters and/or a horizontal distance of at least 200 meters.

In some embodiments the emergency monitoring may comprise maintaining a safe distance from a neighboring vehicle and in particular aerial vehicle including a takeoff safety perimeter of at least 50 meters, and more preferably at least 100 meters and most preferably 200 meters.

Within the context of this application the term vehicle, remotely controlled vehicle, robot, unmanned vehicle, autonomous vehicle, autonomous device, may be used interchangeably to refer to any such device configured to maneuver on at least one or more of: land, sea, or air. Accordingly, such vehicles may refer to terrestrial vehicles, airborne vehicles, airborne vessels, waterborne vehicles, waterborne vessels, amphibious vehicles, amphibious vessels, airborne robots, terrestrial robots, waterborne robots or the like. A non limiting example of an airborne vessel and/or vehicle is a drone.

Within the context of this application any reference to a vehicle and/or robot may be active user controlled, autonomously controlled (non-active user), or semi-autonomously controlled (intermittent user control).

Within the context of this application, an emergency situation associated with a robot and/or vehicle may for example include but is not limited to at least one or more selected from: collision, target avoidance, loss of control, overtake attempt, or the like.

Within the context of this application, an emergency situation associated with aerial vehicle may for example include but is not limited to at least one or more selected from: flightpath interception, midair collision, collision, crash, sudden loss of height, jetstream interception, jet wash, wake turbulence, turbulence, or loss of control of aerial vehicle, overtake attempt, controller overtake attempt, remote overtake attempt, the like, or any combination thereof.

Within the context of this application the various emergency situations identified with the device of the present invention may involve any form of aerial vehicles for example including: unmanned aerial vehicle (UAV), such as a drone, that are remotely controlled by an operator and/or pilot and/or user, and/or a manned aerial vehicle such as helicopters, airplanes, paramotor, powered paraglider, powered parachutes (also known as PPC or paraplane), ultralight aviation device, any form of a manned parachuting device, or the like.

Within the context of this application the term aerial vehicle (AV) may refer to any vehicle capable of undertaking an aerial flightpath that is manned, having an onboard pilot controlling the vehicle, and/or unmanned, and is controlled remotely with a remote pilot and/or user and/or operator. Aerial vehicle may for example include but is not limited to a drone, autonomous aerial vehicle, manned aerial vehicle, helicopters, airplanes, paramotor, powered paraglider, powered parachutes (also known as PPC or paraplane), ultralight aviation device, manned parachute (paratrooper), or the like.

In embodiments the safety device may be provided in the form of an adjunct device that may be seamlessly associated and/or coupled to an vehicle, in a manner that allows the safety device seamless access to sensor data and/or real-time routing and/or movement data relating to the vehicle.

In embodiment the safety device abstracts the safety maneuvering control signal so as to cause an vehicle to change routing path for a limited period of time, sufficient to allow it to avoid a specific identified potential emergency situation.

In some embodiments the safety device provides: a passive scanning mode to identify an emergency situation, an abstracting mode to determine a routing and/or maneuvering control signal to alleviate an emergency situation, and an active control mode for communicating and controlling the maneuverability and/or flightpath of the vehicle, therein acting as a master routing controller wherein the device assumes active control of the vehicle from the user and/or pilot, and finally a returns to passive scanning mode where control is returned to the user and/or pilot.

In embodiments the abstracted control signal may comprise routing directive and/or a flight plan to cause the aerial vehicle to “move aside” and/or alter its flightpath at least for a short period of time sufficient and/or necessary to avoid the emergency situation.

In some embodiments the abstracted control signal may comprise virtual sensory data abstracted by the safety device so as to cause the vehicle to “move aside” and/or alter its route at least for a period of time necessary to avoid the inflight emergency situation.

In embodiments, the control signal may comprise data relating to any one or more sensor(s) and/or module and/or intrinsic onboard system(s) internal and/or intrinsic to the aerial vehicle.

Unless otherwise defined the various embodiment of the present invention may be provided to an end user in a plurality of formats, platforms, and may be outputted to at least one of a computer readable memory, a computer display device, and a printout, a computer on a network or a user.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a schematic illustration of an optional vehicle in the form of an unmanned aerial vehicle (‘UAV’) that is fit with a safety device according to embodiments of the present invention.

FIG. 2A-B are schematic block diagrams of a device according to embodiments of the present invention configured to be fit with an aerial vehicle;

FIG. 3 is a schematic illustrative diagram of a system of a network of devices according to embodiments of the present invention;

FIG. 4 is a flowchart of an optional method for controlling an aerial vehicle according to embodiments of the present invention;

FIG. 5 is a schematic illustration depiction use of the device, system and method according to embodiments of the present invention; and

FIG. 6 shows a schematic illustration of an optional vehicle in the form of an unmanned terrestrial vehicle that is fit with a safety device according to embodiments of the present invention.

### DESCRIPTION OF THE PREFERRED EMBODIMENTS

The principles and operation of the present invention may be better understood with reference to the drawings and the accompanying description.

The following figure reference labels are used throughout the description to refer to similarly functioning components are used throughout the specification hereinbelow.
10 user and/or pilot
100 aerial vehicle (AV);
101t terrestrial vehicle;
102 AV body;
104 motor;
106 propeller;
108 sensor(s) module;
110 controller/electronics
112 remote controller;
150 network of devices;
150m network member;
152 administrator;
155 third party;
200 Safety Device;
200i Integrated Safety Device;
201 control signal;
202 controller and memory module;
204 power supply;
206 communication module
208 GPS module;
210 User Interface (UI) module;
212 Radio Frequency (RF) module;
212a narrow beam antenna;
212b wide beam antenna;
212c omnidirectional antenna;
220 sensor module;
222 three-axis gyro sensor;
224 three-axis accelerometer
226 three-axis digital compass;
228 barometric pressure sensor;

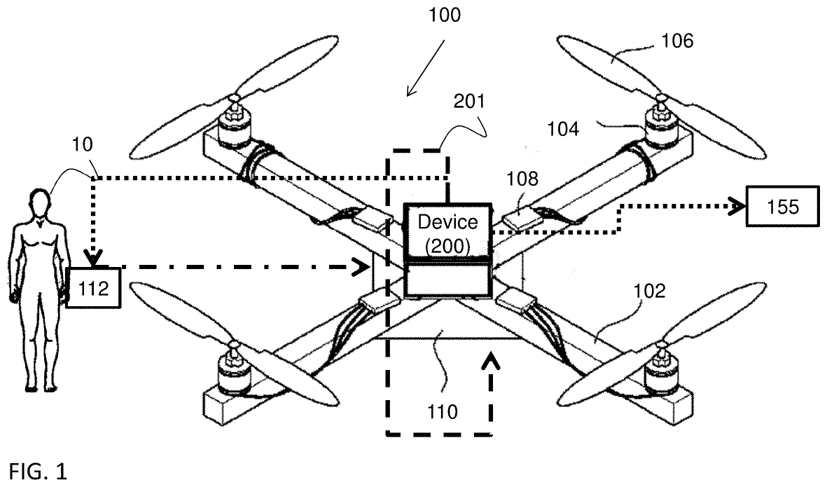

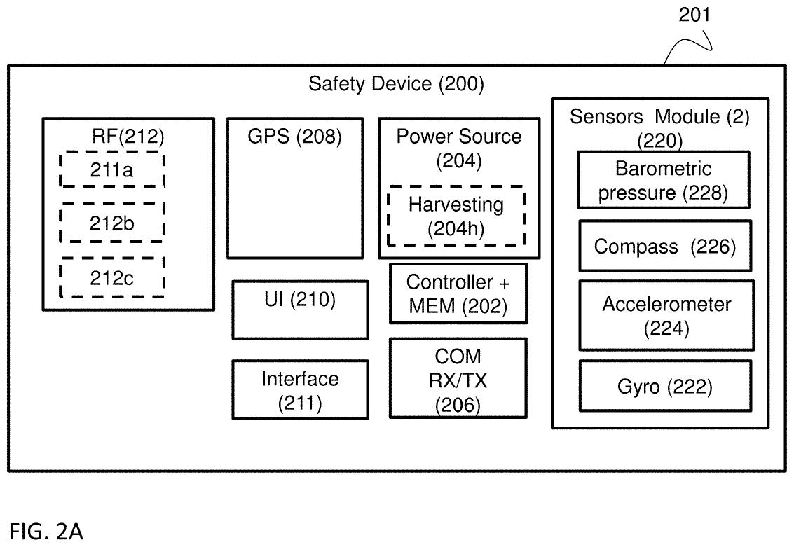

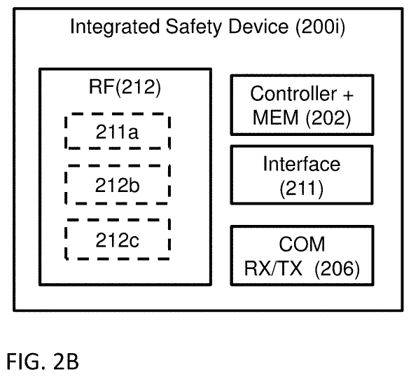

FIG. 1 shows a schematic illustration of a vehicle shown in the form of an aerial vehicle (AV) 100, shown in an optional form of an unmanned aerial vehicle (UAV) and/or drone that is fit with the safety device 200 according to embodiments of the present invention. Safety device 200 may be fit on any form of an aerial device that is manned and/or unmanned. In embodiments device 200, shown in greater detail in FIG. 2A, may be provided as an adjunct device or as an internal/integrated device 200i, for example as shown in greater detail in FIG. 2B. In embodiments, safety device 200, 200i may be associated and/or integrated with various forms of aerial vehicles for example including but not limited to drone, autonomous aerial vehicle, manned aerial vehicle, helicopters, airplanes, paramotor, powered paraglider, powered parachutes (also known as PPC or paraplane), ultralight aviation device, manned parachute (paratrooper), or the like.

FIG. 1 shows an optional embodiment of Aerial vehicle (AV) 100 in the form of a drone that features a body 102 that is securely fit with at least one and more preferably a plurality of motors 104, wherein each motor 104 drives a propeller 106. Control of AV 100 is provided with an onboard control module 110 configured to provide AV 100 with power, communication and steering means. AV 100 further features a plurality of sensors 108 that may be dispersed along body 102 and/or incorporated within control module 110. For example, control module 110 may comprise a flight computer. For example, AV 100 may be a state of the art drone and/or unmanned aerial vehicle, as is shown, that may be controlled remotely by a pilot and/or user 10 with a remote control 112 in communication with control module 110, as is known in the art.

Embodiments of the present invention provide a safety device 200 that may be readily associated with at least a portion of AV 100. Accordingly in some embodiments safety device 200 may be provided in the form of an adjunct device that may be seamlessly associated with and/or added to AV 100 so as to provide it with an additional flight safety feature. In particular, safety device 200 provides a control device capable of monitoring and/or scanning for an emergency situation based on the routing and/or flight path of AV 100. If device 200 detects an emergency situation it is configured to abstract a control signal 201 that allows AV 100 to avoid the emergency situation, therein preventing AV 100 from crashing and/or allows AV 100 to avoid in flight collisions and/or similar failures, for example with other aerial vehicles, and more preferably with other aerial vehicle that are not part of its own formation and/or squad.

Preferably device 200 provides for the early identification of situations that could lead to an inflight collisions and/or failure and/or crash and/or hostile takeovers thus allowing the aerial vehicle 100 the opportunity to circumvent and/or avoid the emergency situation.

In embodiment device 200 is associated with an optional aerial vehicle 100 such that when an emergency situation is identified by device 200, device 200 can abstract and communicate a control signal 201 that is communicated to the controller of aerial vehicle 100. In some instances, wherein the AV 100 is remotely controlled, for example by a user 10 with remote controller 112, as shown, such a control signal 201 is communicated to controller 110 so as to provide user 10 with detailed maneuvers so as to overcome the emergency situation and/or threat. In some embodiments, control signal 201 may circumvent communication with user 10 and may redirect control and/or communication to third party 155 for example including but not limited to a different user, a flight control administrator, a squad leader, a manned aerial vehicle, a pilot from an adjacent aerial vehicle, or the like.

In some embodiments control signal 201 may be a time limited control signal such that it is communicated only for a period of time sufficient to avoid the emergency situation. In embodiments that time limited control signal 201 is provided for up to 20 minute, more preferably up to 10 minutes, more preferably up to 5 minutes, most preferably up to 2 minutes.

In some embodiments control signal 201 may be provided in the form of a “homing” signal and/or instructions wherein the control signal communicated provides the required maneuvers so as to direct aerial vehicle 100 is to a home location and/or base and/or alternative location. Optionally the home location may be a predefined location and/or an abstracted location and/or a determined location and/or a location communicated to device 200 from at least one or more of a user 10, third party 155, administrator 152, or neighboring device 200 in communication therewith. In some embodiments device 200 employs a method for averting inflight collisions by acting as a master flightpath controller preferably by abstracting and communicating virtual and/or simulated sensory data to aerial vehicle 100. The abstracted virtual sensory data is communicated to vehicle 100 so as to allow device 200 to mobilize vehicle 100 to a safer flightpath that avoids the emergency situation until such a time that it is alleviated. For example, device 200 may communicate a control signal 201 comprising a virtual GPS data set to the controllers 110 so as to cause vehicle 100 to “move aside” and/or alter its flightpath at least for a period of time necessary to avoid the inflight emergency situation.

In some embodiments, the virtual sensory data set forming at least a portion of control signal 201 may relate to any one or more sensor(s) and/or module and/or intrinsic onboard system(s) disposed on vehicle 100.

Once the emergency situation has passed and/or voided and/or has been alleviated device 200 disengages control signal 201 from vehicle 100 and re-engages as a monitoring device, providing full control back to vehicle 100 and its operators and/or pilot and/or user 10. Accordingly preferably device 200 engages as a master flightpath controller for limited period of time during an inflight emergency situation wherein the length of the time limited period is sufficient so as to avert the emergency situation.

In some embodiments, preferably for manned aerial vehicles such as helicopters, emergency device 200 may be provided in the form of a scanning device only capable of identifying an emergency situation and suggesting an avoidance maneuver however without the ability to independently perform and/or undertake the maneuver abstracted by control signal 201. In such situations the control signal may be communicated to a user 10 to undertake the communicated maneuver via remote controller 112. Alternatively, the control signal 201 may be communicated to a third party 155 and/or administrator 152 so as to assume control of the vehicle 100 and to perform the abstracted maneuver.

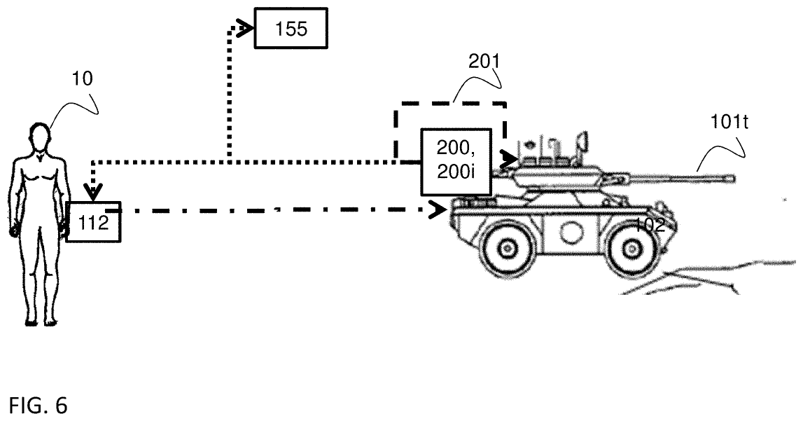

Now referring to FIG. 6 showing the use of device 200 with an alternative vehicle shown in the form of a terrestrial robot 101t that is remotely controlled by user 10 with remote control 112. Device 200 functions in the same manner in a terrestrial and/or waterborne vehicle as that described above where device 200 functions in concert with the internal functional and control modules of the vehicle associated therewith, wherein device 200 is provided to actively monitor the movement and routing data of the vehicle 100, 100t, to as to ensure its safety from various emergency situations. Terrestrial robot 101t may additionally be in communication with a third party device 155 such that in some situation the control signal 201 may be communicated to third party device 155 allowing it to control vehicle 101t.

Now referring to FIG. 2A-B, showing a detailed depiction of safety device 200, 200i according to embodiments of the present invention. FIG. 2A shows a safety device 200 according to an embodiment of the present invention. As described above, device 200 may be utilized to as a passive route monitoring device and/or as an active routing controller so as to prevent and/or alleviate an emergency routing situation, such as collision avoidance.

In some embodiments device 200 may be provided as an adjunct device, FIG. 2A, that is associated and/or coupled with a vehicle 100,101t. In such a configuration device 200 is associated with the sensors and/or controller of vehicle 100 such that device 200 can read and access the intrinsic movement and routing data of vehicle 100,101t.

In embodiments coupling between device 200 and vehicle 100 may be established over a dedicated coupling interface 211 that allows device 200 to access data relating to vehicle 100.

In some embodiments device 200 may be provided in an integrated form 200i and/or an integral part of aerial vehicle 100, for example as a failsafe portion of this control module 110, for example as shown in FIG. 2B.

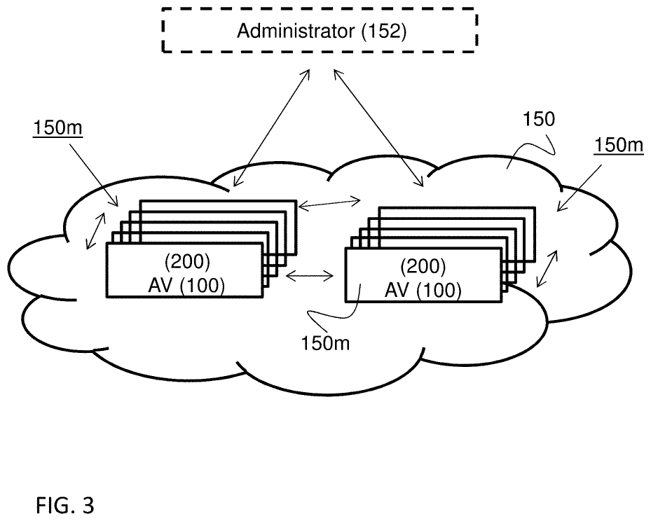

In some embodiments device 200 may function as an independent device that can function either independently and/or interactively in a network setting shown in FIG. 3.

In embodiments, as shown in FIG. 2A, device 200 comprises a controller and memory module 202, a power supply 204, user interface (UI) module 210, a communication module 206, a GPS module 208, Radio Frequency (RF) module 212, and a sensor module 220.

In embodiments sensor module 220 may include and/or comprise a three-axis digital compass 226, a three-axis gyro sensor 222, and a three-axis accelerometer 224 and a barometric pressure sensor 228, or the like.

Optionally three-axis digital compass 226 may be realized in the form of a magnetic field sensor.

In some embodiments sensor module 220 may further comprise an image sensor such as a camera or the like imaging device.

In some embodiments sensor module 220 may further comprise an audible and/or acoustic sensors such as a microphone.

Device 200 is configured to function with GPS data, elevation and/or altitude data provided by sensor module 220.

In embodiments RF communication module 212 may function in a streamlined and/or coordinated manner with communication module 206.

Optionally RF module 212 may be provided with at least one or a plurality of optional antennas for example including but not limited to a narrow beam antenna 212a, directional antenna 212a, a wide beam antenna 212b, or an omnidirectional antenna 212c.

Optionally the RF module 212 may comprise at least one or more RF antenna that may for example be selected from at least one or more of narrow beam antenna, wide beam antenna, omnidirectional antenna, directional antenna, polarizing antenna, or any combination thereof. RF module preferably allows device 200 to be in direct communication with other “neighboring” aerial vehicles comprising device 200.

In embodiments, power source module 204 is preferably provided in the form of a rechargeable battery. Optionally power supply 204 may be further associated and/or fitted with an energy harvesting device for example including but not limited to a solar cells, turbine, piezoelectric pad, any combination thereof or the like device provided to convert kinetic energy to electric potential energy that may be utilized to power device 200.

Controller and memory module 202 preferably integrates and controls device 200 rending it functional and to enable data processing and exchange, so as to abstract control signal 201. In embodiments controller module 202 may further provide for the formation of a network 150 including a plurality of device 200 members 150m so as to form a network of aerial vehicles associated with and/or comprising device 200, for example as is shown in FIG. 3.

Optionally and preferably data processing with processing module 202 further provides for ascertaining the likelihood and/or probability of an emergency situation. Scanning for emergency situations may comprise ascertaining the movement of all vehicles network members 150m forming network 150 (FIG. 3) more particularly based on an analysis of the location, position, flightpath, speed, and directionality of all network members 150m relative to one another, for example as is shown in FIG. 3.

In embodiments, safety device 200 may be in communication with all network members 150m forming network 150; wherein each device 200 is capable of mapping the relative location of all neighboring network members 150m comprising safety devices 200 so as to generate a map ascertaining the likelihood and/or probability of an emergency situation relative to all neighboring devices 200 and network members 150m. Optionally and preferably all safety devices 200 in network 150 may generate such a probability map.

In embodiments a network 150 including a plurality of network members 150m, FIG. 3, may further comprise a network administrator 152. Administrator 152 may be any form of computing and communication device, as will be described in greater detail with respect to FIG. 3.

Controller and memory module 202 provides for storing and processing data associated with aerial vehicle 100 and surrounding network members 150m. Controller and memory module 202 provides for ascertaining likelihood and/or probability of an emergency situation with respect to the vehicle's 100 route and any nearby threats.

In embodiments, User Interface (UI) module 210 provides a user with means for interfacing with device 200 preferably via processor and memory module 202. UI 210 may be provided in optional forms for example including but not limited to keyboard, display, touch screen, touch pad, buzzer, tactile pad, at least one light emitting diode (LED), at least one organic LED (OLED), speakers, microphone or any combination thereof.

In embodiments, communication module 206 provides for communicating with aerial vehicle 100 and/or its associated controller 112. Optionally communication module 206 may further provide for communicating other devices 200 forming network 150, 150m, and/or a network administrator 152.

In embodiments communication module 206 may be realized in the form of a receiver transceiver (Rx/Tx) able to both receive and transmit communication signals. In embodiments communication module 206 may be functionally associated with any communication means incorporated with and/or internal to and/or disposed on aerial vehicle 100.

In some embodiments communication module 206 may be provided with ability to undertake wireless communication for example including but not limited to Bluetooth, ZigBee, cellular communication, WIFI, wired communication, wireless communication, optical communication, any combination thereof or the like.

In embodiments GPS module 208 provides navigation and location device implementation as is known in the art.

In embodiments a Radio Frequency (RF) module 212 facilitates RF communications with communication module 206.

In some embodiments RF module 212 may feature at least one antenna selected from a narrow beam antenna, a wide beam antenna, multi-beam antenna to facilitate transmission of a RF signal.

In embodiments, sensor module 220 comprises a plurality of optional sensors that provide further essential navigational data for example including but not limited to at least one of position, direction, speed, acceleration, angular acceleration, velocity, or the like, to controller 202. Most preferably sensor module 220 includes a three-axis digital compass 226, a three-axis gyro sensor 222, and a three-axis accelerometer 224. In some embodiments sensor module 220 may further comprise barometric pressure sensor 228.

Preferably the data provided by the sensor module 220 enhances the position, directional data provided by GPS module 208. Optionally and preferably controller 202 provides for merging and determining the navigational and positional data obtained from sensor module 220 and GPS module 208.

In embodiments sensor module 220 may further comprise at least one more sensor selected from: temperature sensor, luminosity sensor, digital light sensor, flow-meter, piezoelectric pressure sensor, pressure sensor, barometer, magnetic field sensor, the like or any combination thereof.

In embodiments device 200 may be provided in a housing 201 that is customized to fit with portions of a vehicle 100,10 it for example body 102 and/or controller module 110.

In embodiments device 200 preferably features interface module 211 that facilitate for interfacing and/or associating and/or coupling device 200 with at least a portion of aerial vehicle 100 for example controller module 110 and/or sensor module 108. Interface module 211 may facilitate at least one or both physical and electronic coupling between device 200 and vehicle 100.

FIG. 2B shows a schematic block diagram of an optional embodiment of safety device 200 provided as an internal and/or integrated safety device 200i wherein device 200 is associated and/or integrated with an aerial vehicle preferably along its electronics circuitry preferably control module 110. Safety device 200i provides a scanning mode and active control mode while integrated with the electronics circuitry of aerial vehicle 100.

Safety device 200i comprises controller module 202, communication module 206, RF module 212, and an interface module 211, each functioning in the same manner as that previously described with respect to device 200. Safety device 200i utilizes the power and sensory capabilities provided by the similarly functioning units disposed in vehicle 100 associated therewith. Most preferably interface module 211 provides for coupling and interfacing device 200i with a portion vehicle 100 and most preferably with control module 110.

In some embodiments device 200i may be provided in the form of electronic circuitry that may be integrated with the circuitry provided by an optional vehicle.

In some embodiments device 200i may be provided as an adjunct device providing emergency scanning capable of identifying an emergency situations and suggesting an avoidance maneuver however without the ability to communicate control signal 201. In such embodiments device 200i is provided with appropriate power via interface module 211. Optionally interface module 211 may further provide for receiving sensory data from the associated vehicle. Optionally device 200i may be configured to provide networking capabilities so as to allow associated device to be a member 150m of network 150. For example, the adjunct device 200i may be realized with manned aerial vehicle wherein the user and/or pilot maintain control of the vehicle at all times, for example provided to such aerial vehicles as helicopter, manned parachute (paratrooper), airplanes, paramotor, powered paraglider, powered parachutes (also known as PPC or paraplane), ultralight aviation device, any form of a manned parachuting device, or the like.

In some embodiments, device 200i may further comprise at least one or more additional functional units and/or modules, as described above, for example including but not limited to sensor module 220, GPS module 228, User Interface module 210, power module 204, or the like.

In some embodiments, device 200i may further comprise a power module 204, and is provided to be coupled to stationary and/or static objects that may be considered obstacles for vehicle for example including but not limited to tower, antenna towers, tall buildings, electrical wiring or the like aviation obstacles.

In embodiments any vehicle 100 featuring safety device 200,200i in network 150 may provide a fellow network member 150m to overtake control of the aerial vehicle 100 during an emergency situation so as to avoid and/or circumvent an emergency situation.

In embodiments any vehicle 100 featuring safety device 200,200i in network 150 may allow a network administrator 152 to overtake control of the aerial vehicle 100 during an emergency situation so as to avoid and/or circumvent an emergency situation.

In embodiments any vehicle 100 featuring device 200,200i in network 150 may provide a pilot and/or user 10 of a fellow network member 150m to overtake control of the vehicle 100 during an emergency situation so as to avoid and/or circumvent an emergency situation.

In embodiments any vehicle 100 featuring device 200,200i in a network 150 may provide a pilot and/or user 10 with the capability of relinquishing control of vehicle 100 therein allowing a network administrator 152 or a fellow network member 150m to assume control of the aerial vehicle 100, for example during an emergency situation so as to avoid and/or circumvent the emergency situation.

For example, an emergency situation such as a hostile overtake attempt of an optional aerial vehicle 100 by a non-network member where an attempt to remotely control aerial vehicle 100 with a foreign and/or hostile masking remote controller is identified as an emergency situation. Device 200 may respond to the hostile takeover attempt by allowing a user to either relinquish control of aerial vehicle 100 or to actively assume control of aerial vehicle 100 while allowing at least one of a network member 150m and/or administrator 152, a user and/or pilot of a fellow network member 150m to gain control of the aerial vehicle 100 for the duration of the emergency situation.

FIG. 3. shows a network 150 that may be formed with a plurality of devices 200, 200i each device coupled with individual vehicles 100, therein the plurality of devices form a network 150 that allows each device 200 to be in communication with one another. In some embodiments, communication between devices 200 forming network 150 utilizing RF module 212 to communicate utilizing at least one or more RF antenna 212a,b,c.

Optionally communication between network members 150m featuring safety device 200 may be realized as direct communication or indirect (relayed) communication. Optionally during direct communication at least two or more safety devices 200 are wirelessly associated and/or in communication with one another and capable of exchanging data. Optionally during indirect communication at least three or more devices 200 are wirelessly associated with one another and capable of exchanging data where at least one device unit 200 acts a communication relay station to relay communication between at least two other device units 200.

In some embodiments network 150 may comprise an administrator 152 that may be provided as a higher processing center that is in communication with devices 200 forming network 150. In embodiments administrator 152 may be realized as a server or the like computer or processor capable of providing an overall depiction of network 150 and may optionally provide a graphical display or rendering of the deployed devices 200. Furthermore, administrator 152 may provide a hierarchal ranking and/or ordering of individual network members 150m so as to ascertain how individual network member 150m have to move relative to one another within a given emergency situation.

In embodiments network 150 allows each device 200 to evaluate and provide for ascertaining the risk and/or probability of an emergency situation.

In embodiments network administrator 152 provides for ascertaining the overall risk and/or probability of an emergency situation for individual network members 150m, a group of network members 150m and/or all network members 150m forming network 150.

In embodiments network members 150m utilize data for example including but not limited to at least one of position, direction, speed, acceleration, angular acceleration, velocity, or the like, relating to at least one or more network members to ascertain if there is an emergency situation.

In embodiments, communication between administrator 152 and device 200 may be facilitated using communication modules disposed therein utilizing communication by any contactless, and/or wireless communication protocol as is known in the art, for example including but not limited to cellular communication, ZigBee, Bluetooth, Wi-Fi, the like or any combination thereof.

In some embodiments administrator 152 may be realized as a hierarchal network of computers including a master administrator and a plurality of slave administrators that report into the master administrator. Optionally individual slave administrators may be associated with a subset of a plurality of device 200. Optionally a plurality of slave administrators may collectively provide for depicting the overall situation that may be analyzed and/or displayed by a master administrator unit.

Optionally and preferably administrator 152 may communicate with device 200 in a two way manner allowing an administrator 152, slave or master, to act as an active flightpath controller for at least one or more network member 150 featuring device 200, 200i. For example allowing administrator 152 to actively control the flight path of at least one or more network members 150m via their individual safety device 200,200i by undertaking the method according to the present invention.

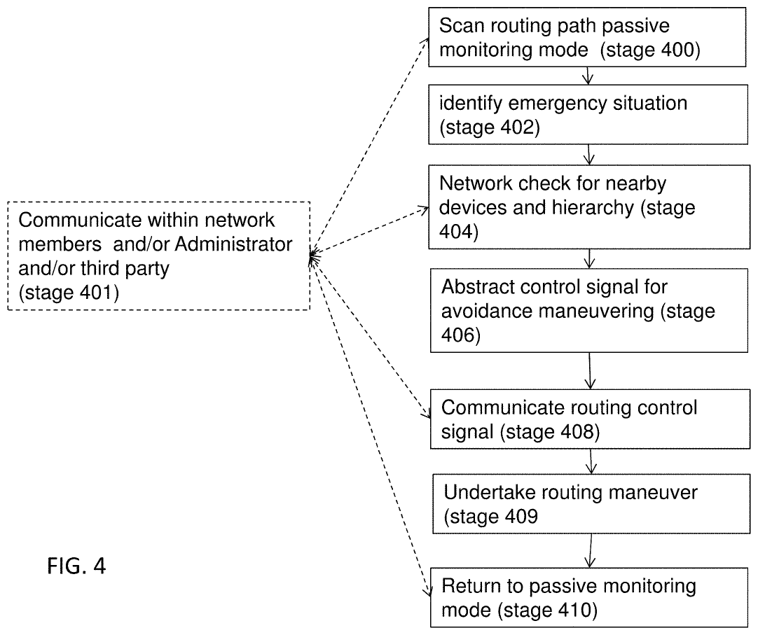

FIG. 4 shows a flowchart depicting the method according to embodiments of the present invention for identifying an emergency situation for an aerial vehicle 100 with device 200, preferably for avoiding crashing, inflight collisions. While the method herein is described with respect to an aerial vehicle, however the method according to embodiments is not limited to use with the aerial vehicle as it may equally apply to any remotely controlled vehicle.

Therein the method utilized with device 200 provides a safety measure capable of overtaking control of an aerial vehicle 100 by altering its flight path of the aerial vehicle 100 associated with device 200. The method according to the present invention provides for rendering and/or abstracting a flight path protocol intended to alter the flightpath of aerial vehicle 200 so as to avoid an emergency situation. The method described below may apply to any form of aerial vehicle 100 featuring device 200, whether the aerial vehicle is standalone, or vehicle 100 is a part of a network 150 featuring a plurality of aerial vehicles 100 in communication with one another, or a standalone vehicle 100 that is in communication with an administrator 152, or a vehicle 100 that form a part of a network 152 that features an administrator.

First in stage 400, device 200 that is associated with an aerial vehicle 100 continuously scans the flight path data made available by the internal data and sensor data from vehicle 100.

In an optional stage 401 device 200 that is part of network 150 may be in two way communication with addition devices 200 forming network 150 and/or an administrator 152. Optional communication stage 401 may be performed at any time.

Next in stage 402 based on data made available to device 200 a potential threat and/or emergency situation is identified. An emergency situation associated with aerial vehicle 100 may for example include but is not limited to at least one or more selected from: flightpath interception, midair collision, collision, crash, sudden loss of height, jetstream interception, jet wash, wake turbulence, turbulence, or loss of control of aerial vehicle, hostile takeover, the like and any combination thereof.

The continued scanning of the flightpath details by way of receiving flight information data and real time sensor data intrinsic to vehicle 100 by device 200 allows identification of potential dangers substantially in real time.

In embodiments where device 200 is a member of and/or a part of a network 150 and/or in communication with administrator 152 additional flightpath data may be made available to device 200 allowing it to predict and/or determine the probability of potential dangers and/or emergency situations relative to the global data available from all members 200 forming network members 150 and/or from administrator 152.

In embodiments network 150 may facilitate identification of the probability of an emergency situation that may occur for all devices 200 forming network 150, the may be established by way of communicating and sharing flight data between at least two or more aerial vehicles 100 featuring devices 200 to identify any flight path interceptions that may occur between two or more network members.

Next in stage 404 if device 200 is a part of a network 150 and/or in communication with administrator 152, device 200 checks for nearby and/or neighboring aerial vehicles 100 so as to further identify and/or ascertain the potential dangers.

Next in stage 406 once all flight path details have been gathered and flight path dangers probability has been ascertained a master flight path control signal is abstracted. The master flight path control signal is determined so as to cause at least one or more aerial vehicle 100 to undertake/employ a flight maneuver so as to avert and/or prevent the emergency situation.

In embodiments the control signal comprises a data set abstracted by device 200 and communicated to any intrinsic member of aerial vehicle 100 to perform a maneuver averting the emergency situation. In some embodiments, control signal comprises abstracted sensor data communicated to at least one of controller 110 and/or sensor module 108 so as to cause aerial vehicle to maneuver out of the danger situation. For example, the control signal may comprise data causing aerial vehicle to reach a particular destination.

In embodiments the abstracted control signal may further comprise data causing aerial vehicle to provide device 200 with full control of vehicle 100, therein removing and/or overriding any other control signals 201 from a user 10. For example, a user 10 controlling vehicle 100 with a remote control will, at least momentarily, will lose and/or disengage from control of aerial vehicle 100 allowing vehicle 100 to be moved out of harm's way.

Next in stage 408 the control signal is communicated so as to activate and maneuver aerial vehicle. 100. The control signal 201 may be communicated to at least one or more of vehicle control module 110, a user 10, to a controlling device 112, a third party 155, a corresponding network member 150m and/or a network administrator 152. In some embodiments the control signal may be communicated via communication module 206 and/or RF module 212. The control signal 201 is communicated to the aerial vehicle 100 via interface 211 and preferably provides device 200 control of vehicle 100 by directly communicating with and/or overtaking control of at least one of the vehicle 100 intrinsic systems selected from control module 110 and/or sensor module 108. In some embodiments the control signal may further communicate with the pilot and/or user 10 of aerial vehicle 100.

In some embodiments, particularly when device 100 is part of network 150, one or more control signals 201 may be abstracted and/or communicated to a plurality of network members 150m forming part of network 150.

In some embodiments the control signal may be communicated to the aerial vehicle's 100 remote pilot and/or user 10 is notified that device 200 is assuming control wherein the remote pilot and/or user will momentarily lose control of vehicle 100 in favor of device 200.

In embodiments the control signal 201 preferably comprise virtual and/or simulated sensory data that is communicated to vehicle 100 so as to mobilize vehicle 100 to a safer flightpath that avoids the emergency situation until such a time that it is alleviated. For example, the control signal may comprise a virtual GPS data set that is communicated to controllers 110 and/or sensor module 108 so as to cause vehicle 100 to “move aside” and/or alter its flightpath at least for a period of time necessary to avoid the inflight emergency situation.

Once the emergency situation has passed and/or voided and/or has been alleviated device 200 disengages as a master control of vehicle 100 and re-engages as a monitoring device, providing control back to vehicle 100 and its operators and/or pilot and/or user (not shown). Accordingly preferably device 200 engages as a master flightpath controller for short period of time during an inflight emergency situation so as to avert the situation.

Next in stage 409 the routing and/or maneuvers abstracted in the control signal 201 are performed.

Next in stage 410, once the emergency situation has been alleviated and the master control signal has been carried out, device 200 disengages control of aerial vehicle 100 and returns to passive monitoring mode, therein providing control of vehicle 100 back to remote pilot and/or user 10.

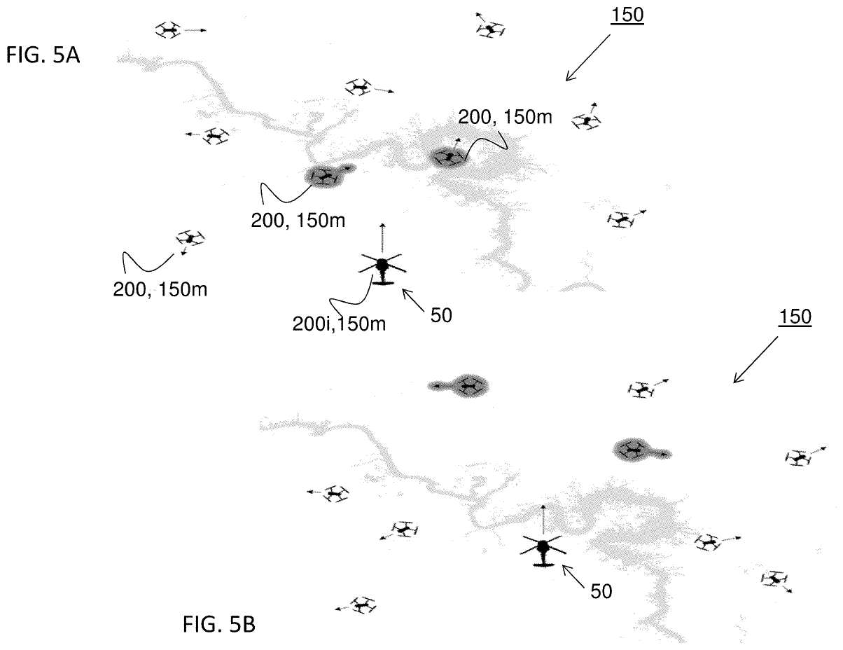

Now referring to FIG. 5A-B show schematic illustration of an example of an optional use of the present invention of device 200, 200i according to the present invention. FIG. 5A-B show a network 150 formed from a plurality of network members 150m each member associated with an aerial vehicle 100 that features a safety device 200,200i according to optional embodiments of the present invention. In the situation shown depicted a manned helicopter 50 featuring an adjunct safety device 200i is maneuvering in a crowded field of aerial vehicles 100 featuring optional safety devices 200,200i according to optional embodiments of the present invention. Each aerial vehicle featuring a safety device 200 is monitored via network 150 to account for data for example including but not limited to at least one of position, direction, speed, acceleration, angular acceleration, velocity, or the like. As the helicopter 50 approaches nearby aerial vehicles 100 featuring devices 200 are made aware of its position, direction, and flightpath via network 150. In such a situation device 200,200i continuously scan the flightpath of all network members 150 to determine if there is high probability of an emergency situation. Upon identification and evaluation of the emergency situation, based on positional, directional data a subset of network members 150, highlighted, abstract a control signal 201 that alters the flightpath so as to allow the helicopter 50 through by “moving” of out harm's way.

Preferably the individual control signal 201 utilized allow each member 150m to move in it optimal direction.

FIG. 5A shows the helicopters approach as two network members 150m are configured to move out of the way while FIG. 5B show same depiction where the network members 150m are out of the way and new members 150m are identified as being problematic and forced to move aside to allow the helicopter a clear and safe flightpath.

In some embodiments, during a particular emergency situation helicopter 50 may act as a third party 155 controller so and allowed to control at least one or more aerial vehicle 100.

FIG. 6 shows an optional embodiment of the present invention wherein safety device 200 is associated with a terrestrial remotely controlled robot 101t. The system function in a manner similar to that described above however with respect to an emergency situation related to terrestrial remotely controlled robots 101t. Such emergency situations may for example include but is not limited to crashing into other objects, friendly fire with other devices featuring safety device 200, 200i. As described above safety device 200 may be provided as an adjust device, or alternatively as an integrated device 200i that is integrated within the terrestrial robot 101t.

There are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

Having described a specific preferred embodiment of the invention with reference to the accompanying drawings, it will be appreciated that the present invention is not limited to that precise embodiment and that various changes and modifications can be effected therein by one of ordinary skill in the art without departing from the scope or spirit of the invention defined by the appended claims.

While the invention has been described with respect to a limited number of embodiments, it will be appreciated that many variations, modifications and other applications of the invention may be made.

What is claimed is:

1) An aerial vehicle safety device the device including: a controller module, communication module, Radio Frequency (RF) module, and an aerial vehicle interface module provided for seamlessly associating and communicating with an aerial vehicle wherein said device has seamless access to sensor data of aerial vehicle; and wherein said device is configured to monitor the flight path for an emergency situation; such that when an emergency situation is identified said device abstracts a control signal including maneuvering instructions configured to circumvent and/or avoid the emergency situation by altering the flight path of said aerial vehicle.

2) The device of claim 1 further comprising power supply.

3) The device of claim 1 further comprising at least one or more selected from: user interface (UI) module, GPS module, a sensor module, digital compass, gyro sensor, and a three-axis accelerometer, barometric pressure sensor.

4) The device of claim 1 wherein said control signal is abstracted with said controller module and wherein said control signal comprises virtual sensory data relating to the at least one selected from: position, direction and speed, acceleration angular acceleration, velocity of said aerial vehicle and wherein said control signal mobilizes aerial vehicle to a safer flightpath that avoids the emergency situation until such a time that the emergency situation is alleviated.

5) The device of claim 4 wherein said virtual sensory data comprises a virtual GPS data set that is communicated to said aerial vehicle causing vehicle to “move aside” and/or alter its flightpath at least for a period of time necessary to avoid the inflight emergency situation.

6) The device of claim 1 wherein said control signal includes a homing signal to mobilize aerial vehicle to a homing location.

7) The device of claim 6 wherein said homing location is selected from: a predefined location, is a location communicated to the vehicle during the emergency situation, a location that is abstracted based on the emergency situation, a location of the vehicle operator, the location of the vehicle's remote controller.

8) The device of claim 4 wherein said virtual sensory data comprises data relating to at least one or more sensor selected form: barometric sensor, GPS, compass, accelerometer, gyro, wherein said virtual sensory data includes data overriding the true sensory data.

9) An aerial vehicle safety system, the system comprising a plurality of safety devices according claim 1, wherein said plurality of safety devices are wirelessly associated with one another and in communication with one another forming a network wherein each of said safety device is in communication with one another utilizing said RF module.

10) The system of claim 9 further comprising a higher processing center in the form of an administrator provided to oversee management and interaction of said plurality of safety devices forming said network.

11) The system of claim 9 wherein said administrator remotely controls any one or a group of said safety devices.

12) The system of claim 11 wherein said administrator remotely defines and incorporate network members.

13) The system of claim 11 wherein said administrator remotely defines the network members.

14) The system of claim 11 wherein said administrator is provided with master control of all network members in the form of safety device.

15) A method for averting an emergency inflight situation of an aerial vehicle with the device of claim 1, the method comprising:
a) associating device with one of an aerial vehicle wherein device has seamless access to data associated with aerial vehicle;
b) undertake passive scanning mode with device to scan inflight data of aerial vehicle with device;
c) identifying an inflight emergency situation;
d) abstracting a control signal including flight control data or sensory data, the control signal configured to contain instructions so as to mobilize said aerial vehicle to circumvent and/or avoid the emergency situation by altering the flight path of aerial vehicle;
e) engage in active control mode, communicate said control signal to aerial vehicle so as to actively control aerial vehicle and disconnect any external user-based control of aerial vehicle;
f) assess if emergency situation has been averted;
g) once emergency situation has been averted, disengage active control mode and reinstate passive scanning mode.

16) A method for averting an emergency inflight situation of an aerial vehicle with the system of claim 9, the method comprising:
a) associating device with an aerial vehicle wherein device has seamless access to data associated with aerial vehicle;
b) undertake passive scanning mode with device to scan inflight data of aerial vehicle with device; and communicate with network members (150) via said RF module or administrator;
c) identifying an inflight emergency situation;
d) communicate said identified emergency situation to neighboring network members or administrator to determine all threats;
e) abstracting a control signal including flight control data or sensory data, the control signal contain instructions so as to mobilize said aerial vehicle to configured to circumvent and/or avoid the emergency situation by altering the flight path of aerial vehicle;
f) engage in active control mode, communicate said control signal to aerial vehicle so as to actively control aerial vehicle and disconnect any external user-based control of aerial vehicle;
g) assess if emergency situation has been averted;
h) once emergency situation has been averted, disengage active control mode and reinstate passive scanning mode.

17) The method of claim 15 wherein said control signal is abstracted with said controller module and wherein said control signal comprises virtual sensory data relating to the position of said aerial vehicle and wherein said control signal mobilizes aerial vehicle to a safer flightpath that avoids the emergency situation until such a time that the emergency situation is alleviated.

18) The method of claim 17 wherein said virtual sensory data comprises a virtual GPS data set that is communicated to said aerial vehicle causing vehicle to “move aside” and/or alter its flightpath at least for a period of time necessary to avoid the inflight emergency situation.

19) The method of claim 17 wherein said control signal includes a homing signal to mobilize aerial vehicle to a homing location.

20) The method of claim 19 wherein the location is selected from: a predefined location, a location abstracted based on the emergency situation, the location of the vehicle operator, the location of the remote controller, a location communicated to device during the emergency situation.

21) The method of claim 17 wherein said virtual sensory data comprises data relating to at least one or more sensor selected form barometric sensor, GPS, compass, accelerometer, gyro, wherein said virtual sensory data includes data overriding the true sensory data.

22) A safety device for remotely controlled vehicles the device including: a controller module, a communication module, a Radio Frequency (RF) module, and a vehicle interface module provided for seamlessly associating and communicating with the vehicle; wherein said device has seamless access to sensory data of the vehicle; and wherein said device is configured to monitor the vehicle's movements and routing for an emergency situation; such that when an emergency situation is identified said device abstracts a maneuvering control signal including maneuvering instructions configured to circumvent and/or avoid the emergency situation by altering the route of said vehicle.

23) The device of claim 22 wherein said vehicle is selected from terrestrial vehicles, airborne vehicles, airborne vessels, waterborne vehicles, waterborne vessels, amphibious vehicles, amphibious vessels, airborne robots, terrestrial robots, and waterborne robots.
